(19) United States
(12) Patent Application Publication
(10) Pub. No.: US 2024/0143423 A1
(43) Pub. Date: May 2, 2024

(54) USING TRAINING DATA FOR LINK RELIABILITY TEST AND PREDICTIVE MAINTENANCE

(71) Applicant: Infineon Technologies AG, Neubiberg (DE)

(72) Inventors: Patrik Eder, Taufkirchen (DE); Christian Mueller, Künzell (DE)

(21) Appl. No.: 17/979,139

(22) Filed: Nov. 2, 2022

(51) Int. Cl. G06F 11/00

(52) U.S. Cl. CPC G06F 11/004

(57) ABSTRACT

Techniques, described herein, include solutions for evaluating a pre-failure condition of a data link. The techniques described allow for detection of the pre-failure condition before actual failure of the data link. A device may receive a first set of training data and compare the first set of training data to a pre-determined set of training data to obtain a first set of values at a first time. The process may be repeated at a second time with a second set of training data and a second set of values respectively. First and second quality metrics may be obtained using the first and second set of values respectively. Based on the first and second quality metrics and a time interval between the first and second times, the pre-failure condition may be determined.

### FIELD

This disclosure relates to systems including data links including techniques for detecting and predicting pre-failure conditions.

### BACKGROUND

Systems may include a plurality of electronics configured to communicate via data links (e.g., a conductive material). The data links may be used to transmit data necessary for performing operations within the system.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a communication system including a device for evaluating a pre-failure condition during a link training procedure in accordance with some aspects of the present disclosure.

FIG. 2 is a schematic diagram illustrating a process for evaluating a pre-failure condition in accordance with some aspects of the present disclosure.

FIG. 3 is a schematic diagram illustrating a process for evaluating a pre-failure condition in accordance with some aspects of the present disclosure.

FIG. 4 illustrates a Finite Impulse Response (FIR) filter included in a Peripheral Communication Interface express (PCIe) transmitter.

FIG. 5 illustrates an example signal transmitted by a PCIe transmitter.

FIGS. 6-8 illustrate a series of tables that show three training sessions occurring over a PCIe bus interface in time, wherein changes in a quality factor of the PCIe bus interface are used to determine a pre-failure condition of the PCIe bus interface.

FIG. 9 is a block diagram illustrating a communication system including a device for evaluating a pre-failure condition in accordance with some aspects of the present disclosure.

FIG. 10 is a logic flow for determining a pre-failure condition in accordance with some aspects of the present disclosure.

FIG. 11 is a logic flow for determining a pre-failure condition in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Communication systems include a plurality of electronic devices configured to transmit/receive data over a conductive link. The devices may communicate with one another by transmitting and receiving data over the conductive link. As the complexity of electronics has increased over time, the use of high speed data links has risen in order to support increasingly complex operations. High speed conductive links enable transmission of large amounts of data in short periods of time, but are very sensitive and require good signal integrity.

The quality of such conductive links is an important factor to consider. A high quality conductive link may result in fewer errors in data transmitted using said conductive link and better link reliability. Conversely, a low quality conductive link may result in a large amount of errors in the data, which may cause failures and interrupt normal operation of the system.

Over time, conductive links may degrade and fail due to many factors. Systems such as automotive and industrial systems are often exposed to harsh environments which may include vibrations, humidity, and widely ranging temperatures. Such harsh environments may accelerate degradation of conductive links and more frequent failures may be experienced as a result. Failure of a conductive link can require large amounts of time and money to fix (e.g., in industrial systems), or can raise safety concerns (e.g., in automotive systems). In order to avoid conductive link failure, when possible, a mechanism to monitor the conductive link and flag conductive link failure before it occurs is desired. Accordingly, the present disclosure relates to techniques that monitor conductive link quality and determine pre-failure conditions for conductive links.

In some aspects, a link training procedure is performed between a first device and a second device. The first device may transmit a first set of training data via a conductive link. The training data may include a set of pre-determined training data. The second device may perform a comparison between the received first set of training data and the pre-determined training data to obtain a first set of values. The first set of values may be used to determine a first quality metric for the link. A pre-failure condition may be determined based on the first quality metric. For example, if the first quality metric is less than a pre-failure threshold value and/or if a rate of change of successive quality metrics exceeds a pre-failure threshold value, then the quality of the data link is no longer sufficient, and the pre-failure condition is determined. Notably, because the pre-failure condition is determined before the data link actually fails, flagging the pre-failure condition allows the data link to be replaced and/or repaired prior to complete failure of the data link and can improve safety and/or save time or money associated with complete failure of the data link.

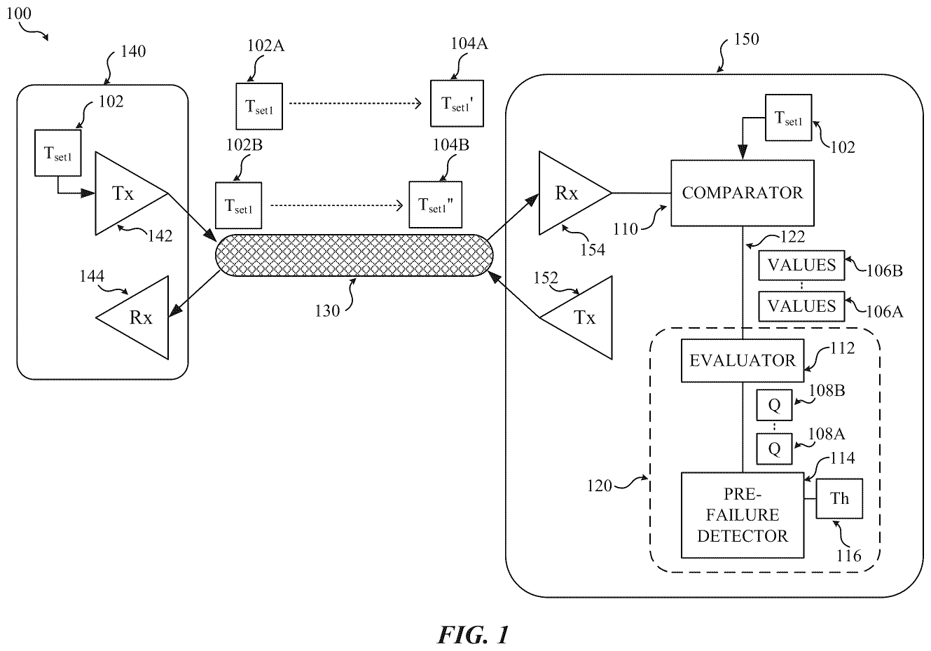

FIG. 1 is a block diagram illustrating a communication system 100 including a device for evaluating a pre-failure condition during a link training procedure in accordance with some aspects. The link training procedure is performed between a first device 140 and a second device 150 over a conductive link 130 within the communication system 100. The first device 140 comprises a first transmitter 142 and a first receiver 144, and the second device 150 comprises a second transmitter 152, a second receiver 154, a comparator 110, and pre-failure processing circuitry 120. The pre-failure processing circuitry 120 is coupled to the comparator 110 via connection 122, and comprises an evaluator 112 and a pre-failure detector 114.

In some cases, the conductive link 130 can be a wireline connection, such as a metal wire, a coaxial cable, and/or a conductive trace on an integrated circuit or printed circuit board; or the conductive link 130 can be a wireless conductive link (e.g., Earth's atmosphere). In some cases, the conductive link can use a standard communication bus interface, such as a Peripheral Component Interconnect (PCI) bus (e.g., PCIe), a Universal Serial Bus (USB) bus (e.g., USB2.0), a Gigabit Ethernet (GbE) connection. However, in other cases the conductive link can be a proprietary communication standard. Although the present examples below are described from the perspective of the receiver 154 of the second device 150 receiving data over the conductive link, it is appreciated that the techniques described herein can be extended to the transmitter 152 of the second device 150 and/or the transmitter 142 and/or receiver 144 of the first device 140 without departing from the scope of the present disclosure.

Prior to initial link training, the first device 140 and second device 150 each know a pre-determined set of training data (Eel) 102, which is often specified in a communication standard, such as a Peripheral Component Interconnect (PCI) standard or a proprietary communication specification. The pre-determined set of training data (Tₛₑₜ₁) 102 can be a predetermined pattern of bits, symbols, etc., which are often manifested as a time-varying voltage or current communicated over the conductive link 130.

During initial link training, the first device 140 transmits the pre-determined set of training data Tₛₑₜ₁ 102a via the conductive link 130 using transmitter 142. However, due to oxidation, corrosion, water intrusion, bad connectivity, or other sources of noise or signal attenuation on the conductive link 130, the pre-determined set of training data Tₛₑₜ₁ 102a may be degraded when in transit to the second device 150. Therefore, the second device 150 receives a first set of training data Tₛₑₜ₁′ 104a using receiver 154, but the first set of training data Tₛₑₜ₁′ 104a may be identical to or may differ from the pre-determined set of training data Tₛₑₜ₁ 102a, due to errors that may arise in the conductive link 130, transmitter 142, and/or receiver 154.

The comparator 110 is configured to compare the first set of training data Tₛₑₜ₁′ 104a to the pre-determined set of training data Tₛₑₜ₁ 102a, which is already known by the comparator 110. Since the pre-determined set of training data Tₛₑₜ₁ 102a is already known, the comparator 110 can identify any discrepancies between the pre-determined set of training data Tₛₑₜ₁ 102a and the first set of training data Tₛₑₜ₁′ 104a, and thereby provide a first set of values 106a. In some aspects, the first set of values 106a includes a bit error rate value that characterizes an error rate (e.g., differences) between the pre-determined set of training data Tₛₑₜ₁ 102a and the first set of training data Tₛₑₜ₁′ 104a. For example, if the pre-determined set of training data Tₛₑₜ₁ 102a includes one-hundred predetermined bits (e.g., of repeating pattern 10101010 . . . ) and the first set of training data Tₛₑₜ₁′ 104a has one-hundred bits that differ by only a single bit, the bit error rate would be 1/100 or equivalently 1%.

The evaluator 112 is configured to evaluate the first set of values 106a to obtain a first quality metric 108a. The first quality metric 108a indicates a quality of the conductive link 130 for data transmission when the first set of training data 104a was received. For example, the first set of values 106a can correspond to a first set of errors counts, and the first quality metric 108a is inversely proportional to the first set of errors counts (e.g., higher error count results in a lower quality metric, such that a minimum error count (e.g., 0) may correspond to a maximum value of the quality metric (e.g., 100) and a maximum error count (e.g., 1000) may correlate to a minimum value of the quality metric (e.g., 0)).

In some cases, the pre-failure detector 114 is configured to determine a pre-failure condition based on the first quality metric 108a and a threshold value 116. In some aspects, the threshold value 116 is a pre-failure threshold value, and the pre-failure condition is determined when the first quality metric 108a is less than the pre-failure threshold value. The pre-failure threshold value may represent an acceptable quality of the conductive link. A value of the first quality metric 108a below the pre-failure threshold may indicate a pre-failure condition. For example, if the threshold value 116 is 42, so long as the first quality metric 108a is greater than or equal to 42, the quality of the conductive link 130 is still acceptable; but if the first quality metric 108a drops to 41, then the pre-failure condition is flagged. Thus, under this pre-failure condition, some level of successful data transfer still exists between the first and second devices, but the quality and/or data rate of the data link is trending downward and as such the pre-failure condition is flagged, which can trigger a warning to a user so remedial action can be take prior to complete failure of the data link.

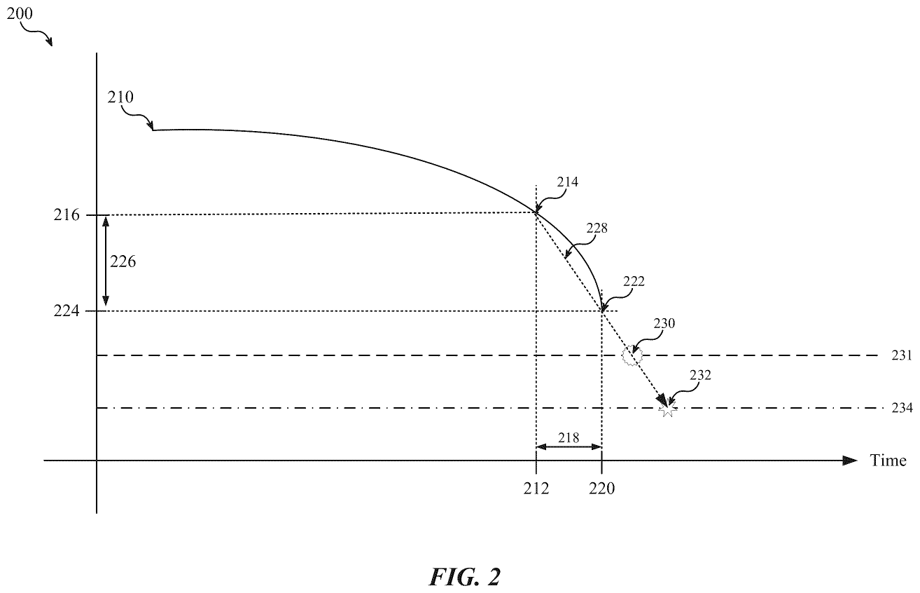

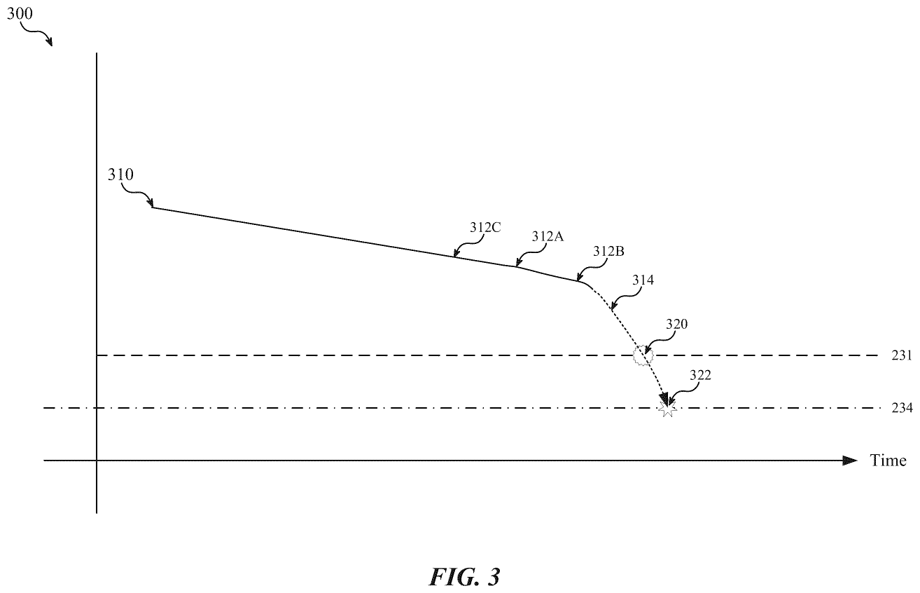

In some cases, the link training procedure is repeated from time to time, and each time the link training procedure occurs the value of the quality metric is determined and stored. Thus, FIG. 1 illustrates another time when the first device 140 re-transmits the pre-determined set of training data Tₛₑₜ₁ 102 via conductive link 130 as 102b using transmitter 142. In response, the second device 150 obtains a second set of training data Tₛₑₜ₁″ 104b. Due to errors that may arise at the conductive link 130, transmitter 142, and/or receiver 154, the second set of training data Tₛₑₜ₁ 104b may not be identical to the pre-determined set of training data Tₛₑₜ₁ 102. By comparing the second set of training data Tₛₑₜ₁″ 104b to the pre-determined set of training data Tₛₑₜ₁ 102b, the comparator 110 obtains a second set of values 106b. The evaluator 112 evaluates the second set of values 106b to obtain a second quality metric 108b, which reflects the quality of the conductive link during the second time and which can differ from the first quality metric 108a. The pre-failure detector 114 then compares the first quality metric 108A to the second quality metric 108b, and if the rate of change between the first quality metric 108a and second quality metric 108b is greater than a predetermined threshold, then the pre-failure detector can indicate a pre-failure condition is present. For example, if there is a significant amount of time between the link training procedures and/or the conductive link 130 is damaged between the link training procedures, the conductive link 130 can become “degraded”. Based on a difference between the first and second quality metrics and a time between the link training procedures, the pre-failure condition may be determined. For example, if the difference between the first and second quality metrics indicates that the conductive link 130 has degraded significantly over a short period of time, then the pre-failure condition may be determined. Additional or alternative techniques that may be performed by the pre-failure detector 114 for detecting the pre-failure condition are described further in this disclosure with reference to FIGS. 2-3.

Certain systems that implement high speed links such as peripheral component interconnect express (PCIe), gigabit ethernet, universal serial bus (USB), double data rate (DDR), and the like may perform link training procedures upon system startup as part of normal operations. The link training procedures and the aforementioned pre-failure detection techniques may be performed upon startup or in response to other events (e.g., during idle phases, upon key off for automotive, at periodic time intervals, at random time intervals, etc.). By frequently checking for pre-failure of the conductive link, the risk of catastrophic failure of the link may be avoided or at least minimized.

Since devices utilizing high speed links often perform link training procedures during normal operation, the aforementioned pre-failure detection techniques may be performed without interrupting normal operations. Furthermore, the aforementioned techniques may be implemented by hardware, software, or a combination of both. In the example of software, the techniques may be implemented by a processor already present on the device. The need for additional hardware is thereby eliminated along with the costs associated therewith.

FIG. 2 is a schematic diagram illustrating a process for evaluating a pre-failure condition in accordance with some aspects. In some aspects, the aforementioned techniques are implemented in order to estimate a quality of a data link. This may be visualized as graph 200, where the x-axis represents time and the y-axis represents the quality of the data link (e.g., data rate and/or data error rate over the data link). A curve 210 represents the actual quality of the data link over time, which may be unknown to the system.

At first time 212, the system undertakes a first link training procedure 214 and obtains a first quality metric 216. In some aspects, the first link training procedure 214 is initiated in response to a triggering event. As an example, the system starts up at the first time 212 and, as part of system start up, the first link training procedure 214 is performed and the first quality metric 216 is determined for the link. Then during time 218, the system performs normal data transfer using the “trained” link that was established to the first link training procedure 214. The duration of this normal data transfer can range from an order of milliseconds to an order of years. However, during this time 218, the system does not re-evaluate the quality metric, which allows for efficient data transfer in many regards, but which also makes the system susceptible to undetected/unknown changes in the quality metric.

At some later point in time 220, another trigger event occurs which triggers a second link training procedure 222. During the second link training procedure 222, the system starts up again and re-determines the quality metric for the data link—here a second value 224 for the quality metric is determined. Additional link training procedures can also be carried out, with quality metrics being determined and stored for each link training procedure. By tracking the quality of the conductive link (e.g., by looking at the quality metric) over time, pre-failure of the conductive link can be detected. For example, if the time 218 between the first and second link training procedures is very small, and the difference 226 between the first and second quality metrics is very large (such that a ratio of 218 to 226 is less than some predetermined threshold or equivalently, if a ratio of 226 to 218 exceeds a predetermined threshold), then it is possible that the conductive link was damaged while the system was shut off (e.g., during 218 between the first and second training sessions). The following techniques show some examples of how the pre-failure condition may be determined based on the quality metrics.

A rate of change is determined based on the values of the first and second quality metrics 216, 224 and a time interval 218 between the first and second times. The pre-failure condition may be determined based on the rate of change of the quality metric. For example, if the rate of change of the quality metric is greater than a rate of change threshold value, then the pre-failure condition is determined. The rate of change threshold value may be pre-determined, or based on previous data (e.g., quality metrics obtained before the first quality metric 216).

In some aspects, linear extrapolation is performed using the first and second quality metrics 216, 224 to generate an extrapolated curve or line 228. The extrapolated curve or line 228 represents a predicted value of the quality metric over time, and may be used to predict when the data link will reach a failure and/or pre-failure condition. Following the extrapolated curve or line 228, the pre-failure condition is predicted to be reached at 230 when the extrapolated quality metric value falls below the pre-failure threshold 231. The failure condition is predicted to be reached at time 232 when the extrapolated quality metric value falls below the failure threshold 234, which may be less than the pre-failure threshold 231. In some aspects, the pre-failure condition is determined when the failure condition is predicted to be reached within a pre-failure time period. For example, in response to a predicted time until failure being less than a pre-failure threshold value (e.g., an acceptable time until failure). This may occur if the rate of degradation of the data link has rapidly increased, as shown by the negative parabolic shape of the curve 210 during time 218. Thus, prior to 218 the rate of quality metric decrease is less than a predetermined threshold (no pre-failure condition), but between 212 and 220, the rate of quality metric decrease exceeds the predetermined threshold and the pre-failure condition is flagged.

FIG. 3 is a schematic diagram illustrating a process for evaluating a pre-failure condition in accordance with some aspects. This may be visualized as graph 300, where the x-axis represents time and the y-axis represents the quality of the data link. A curve 310 represents the actual quality of the data link over time, which may be unknown to the system.

In some aspects, a first quality metric 312A is obtained at a first time using the techniques previously described. Subsequently, the process is repeated to obtain a second quality metric 312B at a second time. The first and second quality metrics 312A, 312B may be used along with the first and second times to obtain a quality function defining future predicted values of the quality metric over time. An extrapolated curve 314 is illustrated showing the future predicted values. In some aspects, the quality function is further based on a third quality metric 312C from a third time before the first and second times. Although not illustrated, the quality metric may be further be based on a plurality of quality metrics at a plurality of times preceding the third time. The quality function may be determined using a “smart” approach, such as Kalman filtering or an appropriate neural network.

In some aspects, the quality function is used to predict when the data link will reach a failure and/or pre-failure condition. Following the extrapolated curve 314, the pre-failure condition is predicted to be reached at time 320 when the extrapolated quality metric value falls below the pre-failure threshold 231. The failure condition is predicted to be reached at time 322 when the extrapolated quality metric falls below the failure threshold value 234. In some aspects, the pre-failure condition is determined when the failure condition is predicted to be reached within a pre-failure time period. For example, in response to the predicted time until failure being less than a pre-failure threshold value.

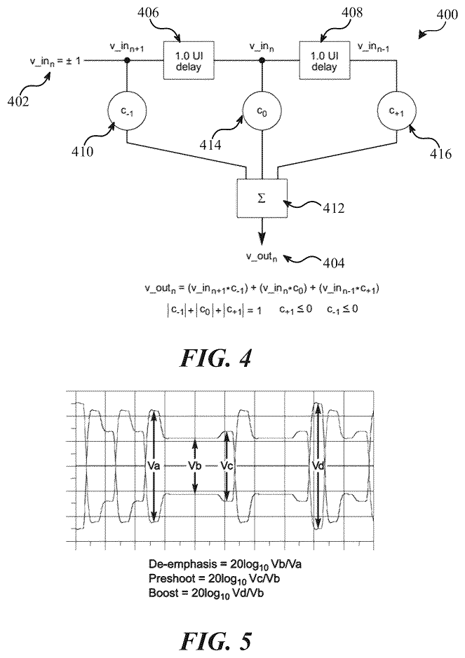

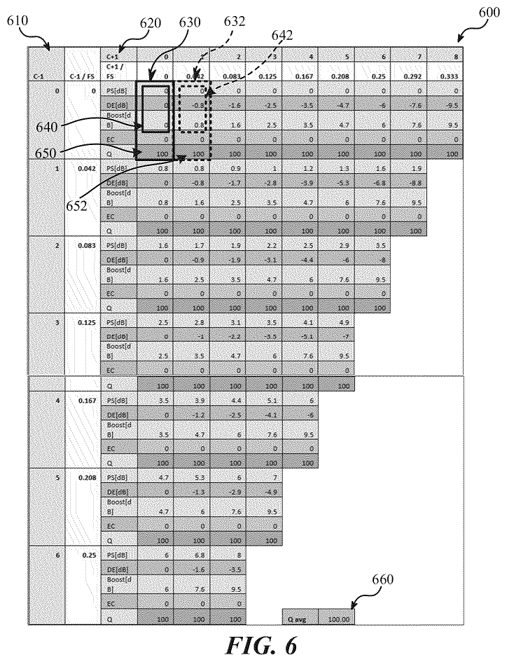

FIGS. 4-8, which will be discussed in more detail in following paragraphs, are a series of drawings that collectively illustrate aspects of three training sessions over a PCIe bus interface between a transmitter and a receiver to determine a pre-failure condition. Briefly, FIG. 4 shows a Finite Impulse Response (FIR) filter that is included in a transmitter; FIG. 5 shows an example of a transmitted signal from the transmitter; and FIGS. 6-8 show a series of three tables that illustrate three different training sessions over the PCIe bus interface, with each table using varying values of the three FIR coefficients. The following text describes a method to determine quality factors at various times for the PCIe bus interface, and how these quality factors can be used to determine the pre-failure condition. Although this example is described below with regards quality factors being determined when a first device (e.g., a CPU motherboard) transmits data to a second device (e.g., an add-in card), it can also be calculated in the other direction.

Turning now to FIG. 4, one can see a Finite Impulse Response (FIR) filter 400 included in a transmitter (e.g., transmitter 142 of FIG. 1). The FIR filter 400 includes a voltage input 402 and a voltage output 404, with a first 1.0 UI (Unit Interval) delay block 406 and a second 1.0 UI delay block 408 arranged between the voltage input 402 and voltage output 404. A first coefficient path 410 (which may correspond to a precursor coefficient, c₋₁) extends between a summation block 412 and a point between the voltage input 402 and the first 1.0 UI delay block 406. A second coefficient path 414 (which may correspond to a cursor coefficient, c) extends between the summation block 412 and a point between the first 1.0 UI delay block 406 and the second 1.0 UI delay block 408. A third coefficient path 416 (which may correspond to a post-cursor coefficient, c₊₁) extends between the summation block 412 and an output of the second 1.0 UI delay block 408. The sum of the 3 coefficients is defined to be 1, such that the training sessions described further herein with regards to FIGS. 6-8 show only two of the three coefficients (e.g., c₋₁ and c₊₁), as the third coefficient (e.g., co) can be calculated from the first two coefficients.

FIG. 5 shows signals provided by the transmitter in accordance with various equalization ratios as the transmitter transmits signals during training Due to the 1.0 UI delay blocks 406, 408, when the voltage input changes, this change will propagate through each of the 1.0 UI delay blocks in the FIR, causing the amplitude of the transmitter to be driven to its nominal value (Va). If the configuration has De-Emphasis (DE) enabled, the transmitted signal will drop after 1 UI to the de-emphasis level Vb. In case no de-emphasis is enabled, the signal will remain at Va. One UI before the next data change (pre-cursor) the signal may change its value to level Vc if pre-shoot is enabled. Vd is shown for illustration purposes only as it shows the maximum amplitude the transmitter can drive. Depending on the settings, Va may not reach the full level of Vd. The amplitude value of Va and Vb can be calculated based on the full swing (FS) level Vd.

FIG. 6 shows a table depicting an example of a first training session 600 carried out between the first device and the second device. The first training session is divided into a plurality of timeslots, and the first coefficient 610, second coefficient (not illustrated), and third coefficient 620 training parameters are adjusted during each timeslot of the plurality of timeslots. For example, during a first timeslot 630, the training parameters of a transmitter (e.g., transmitter 142) and a receiver (e.g., receiver 154) are tuned to a first set of values. In particular, during the first timeslot 630, the first coefficient is set to 0 and the third coefficient c₊₁ is set to 0, meaning that the second coefficient c (not illustrated) is set to 1. With the transmitter using these coefficients in its FIR filter, the transmitter transmits a pre-determined set of training data. The receiver receives a first set of training data, which may or may not be identical to the pre-determined set of training data (e.g., due to errors that arise during transmission), and records various values in the first timeslot 630 including PS (Pre-Shoot value in dB), DE (De-Emphasis value in dB), Boost (Boost-value in dB) as indicated by 640. Based on these values 640 and/or received data, the receiver determines an EC (Error Count, showing the number of errors which occurred for this coefficient combination during link training). Based on these values, the receiver determines a first-timeslot-first-training-session quality (Q) metric 650 for this first timeslot 630. The PS, DE, and Boost values may, for example, be determined using the first coefficient, the second coefficient, and the third coefficient.

In some examples, the first-timeslot-first-training-session quality metric 650 (as well as other timeslot training quality metrics) is calculated in the following way: an error count of 0 means highest quality which is shown as a Q factor of 100. If the error-count reaches the value of 1000 there is no quality of the link given for this combination of coefficients and therefore the Q factor is 0. For EC values between 0 and 1000 the Q value is calculated by 100−0.1*EC. Please note the linear relationship of Q and EC is just an example. Depending on the implementation the relation between EC and Q can be non-linear or even influenced by more than just an error count. In case there is no combination with 0 errors, the link can be detected to be a “fail” irrespective of the calculated quality factor.

After the first-timeslot-first-training-session quality metric 650 is determined, the training session continues to the next timeslot 632, and the transmitter and receiver adjust their training parameters. Thus, for a second timeslot 632, the training parameters of the transmitter and receiver are tuned to a second set of values. More particularly, the first coefficient is set to 0 and the third coefficient c₊₁ is set to 0.042, meaning that the second coefficient c is set to 0.958. While the transmitter uses these updated coefficients in its FIR filter, the transmitter again transmits the pre-determined set of training data. The receiver again receives the set of training data, which may or may not be identical to the transmitted set of training data (e.g., due to errors that arise during transmission), and again records various values including PS (Pre-Shoot value in dB), DE (De-Emphasis value in dB), Boost (Boost-value in dB) in 642, and determines EC (Error Count, showing the number of errors which occurred for this combination during link training). Based on these values, the receiver determines a second-timeslot-first-training-session quality metric 652 for this second timeslot 632. Training continues in this way, whereby for each timeslot the training parameters including the first, second, and third coefficients are adjusted; and a corresponding timeslot-training-session quality (Q) metric is determined.

At the end of the training session 600, an overall quality factor Qavg 660 is calculated for the entire first training session by taking the average value over all Q values. Thus, a first training session quality metric 660 is obtained based on the timeslot quality metrics (e.g., 650, 652). The first training session quality metric 660 may represent an overall quality of the link as determined in the first training session. In some aspects, the first training session quality metric 660 is based on an average of the timeslot quality metrics 650, 652, as well as additional timeslot quality metrics measured during respective timeslots of the first training session. In some aspects, the first training session quality metric 660 may be based on the timeslot quality metrics 650, 652 (and optionally, further based on the plurality of additional timeslot quality metrics) where each timeslot quality metric is weighted according to an algorithm based on the corresponding values or corresponding coefficients (e.g., the corresponding values of the first coefficient 610, second coefficient (not illustrated), and third coefficient 620). In some aspects, the weighting of the algorithm is based on one or more training session performed before the first training session.

In some aspects, a pre-failure condition may be determined based on the first training session quality metric 660. For example, if the first training session quality metric 660 is less than a pre-failure threshold value, then a pre-failure condition can be flagged.

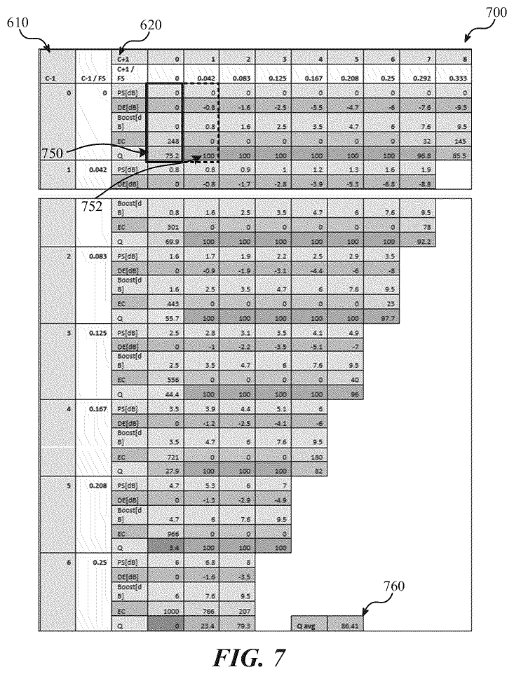

FIG. 7 shows a table depicting an example of a second training session 700 carried out between the first device and the second device. The second training session is performed in a similar manner to the first training session, and the second training session is performed after the first training session. In this way, a first-time-slot-second-training-session quality metric 750 and a second-time-slot-second-training-session quality metric 752 are determined. A second training session quality metric 760 is obtained based on the first-timeslot-second-training-session quality metric 750 and the second-timeslot-second-training-session quality metric 752.

In some aspects, a pre-failure condition is determined based on the first training session quality metric 660 and the second training session quality metric 760. For example, if a difference between the first session quality metric 660 and the second training session quality metric 760 exceeds a predetermined threshold (or if a rate of decrease between the first and second quality metrics when accounting for the respective times the quality metrics were determined exceed a predetermined threshold), then a pre-failure condition can be flagged. Further, as described with reference to FIG. 2, linear extrapolation may be performed utilizing the first training session quality metric 660 and the second training session quality metric 760. As shown by FIGS. 6-7, the second training session quality metric 760 is less than the first training session quality metric 660. Based on an extrapolated rate of change exceeding a rate of change threshold the pre-failure condition may be determined. Alternatively, a predicted time until failure may be calculated based on the linear extrapolation. If the link is predicted to fail within a pre-failure time period, then the pre-failure condition is determined.

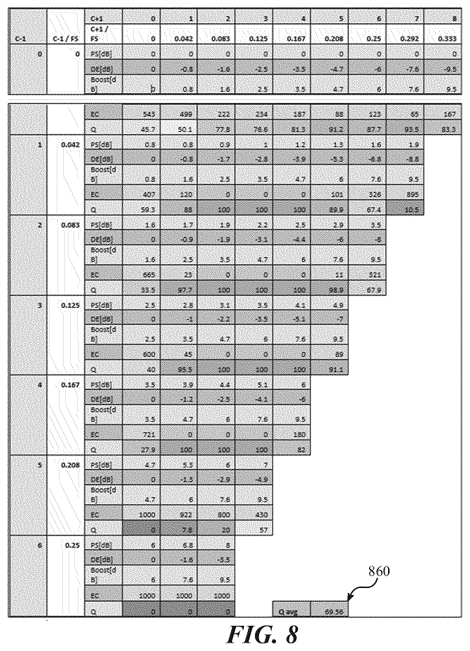

In some alternative aspects, a quality function is derived using the first training session quality metric 660 and the second training session quality metric 760, as described with reference to FIG. 3. In some aspects, as shown by FIG. 8, a third training session is performed to obtain a third quality metric 860. In some aspects, the quality function is further based on the third quality metric 860. The quality function may be used to predict a time until failure, and if the predicted time until failure falls within a pre-failure time period, then the pre-failure condition is determined. On the borders of the parameter space of FIG. 8, the error count starts to increase (or even fail for the bottom row). Compared to FIG. 7, which has a quality factor of 86.5, the quality factor in FIG. 8 drops for these fields with errors and leads to an overall decrease in the quality factor. Because many combinations cannot complete with 0 errors, the average quality factor reduces from initially 86% in FIG. 7 to less than 70% in FIG. 8, which can trigger an alarm of a pre-failure condition (e.g., a possible total fail of the link in the near future). Note that in this example, in some cases the pre-failure condition can be flagged based solely on the fact that a quality factor of 70% is less than a predetermined quality factor threshold; but in other cases the pre-failure condition can be flagged because the difference between 86% and 70% over a given time is higher than a predetermined quality factor rate threshold. Please note that the TX quality factor is not the only factor to be monitored, as stated above the receive path is monitored in addition and if the link contains more than one data lane, the other lanes are taken into account leading to an overall quality function with more than just one input parameter.

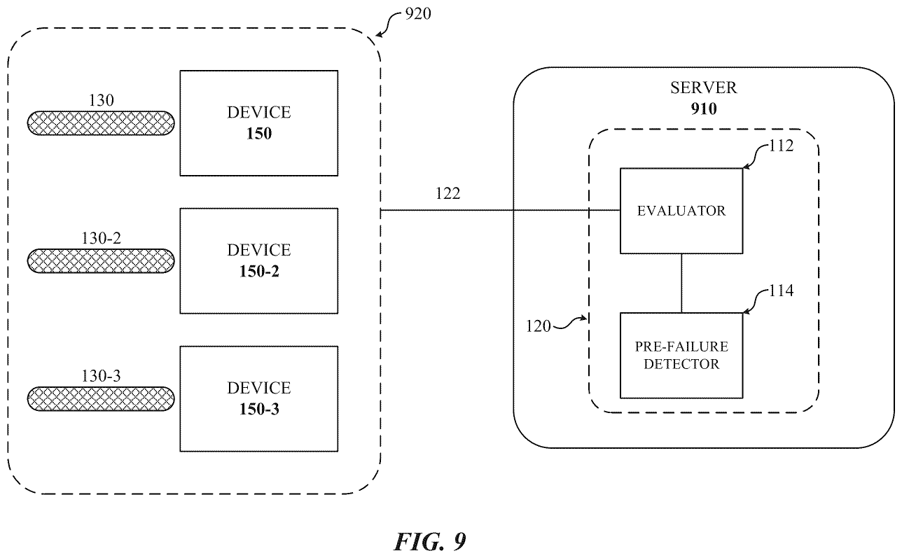

FIG. 9 is a block diagram illustrating a device for evaluating a pre-failure condition in accordance with some aspects of the present disclosure. Illustrated is a server 910. In some aspects, the server 910 comprises the pre-failure processing circuitry 120, including the evaluator 112 and the pre-failure detector 114. The server 910 communicates with a device 150 using connection 122. The server 910 determines the pre-failure condition using the various techniques as previously described. In some aspects, the server 910 has more processing power than the device 150, enabling the server 910 to perform computationally intensive algorithms to predict link failure/pre-failure.

In some aspects, the device 150 is part of a group of devices 920. The group of devices 920 may comprise devices 150, 150-2, 150-3 each configured to perform link training with other devices (not shown) using conductive links 130, 130-2, and 130-3 respectively. Each device may perform link training from time to time (e.g., upon system startup or in response to other events), and transmit data regarding this link training using connection 122 (e.g., a wireless connection) to the server 910. The information receiver by the server 910 from the group of the devices 920 may be used to track quality metrics for the conductive links 130, 130-2, and 130-3 over time. In some aspects, the devices 150, 150-2, 150-3 are of the same or similar type. By receiving data from a plurality of devices 150, 150-2, 150-3 are all communicating with the server 910, the server 910 may have a wide range of data to use for failure prediction of the conductive links 130, 130-2, and 130-3. Since the devices are of the same or similar type, data related to failure over time of one device may indicate useful information about potential future failure of another device. For example, the server 910 may store data (e.g., in a memory). An algorithm may be used to determine a quality function, and the algorithm may be based on the stored data. “Smart” techniques such as machine learning could be implemented to better analyze the entire data set and make future predictions. Centralized processing at the server 910 may allow for more complex prediction algorithms (e.g., due to more available compute power).

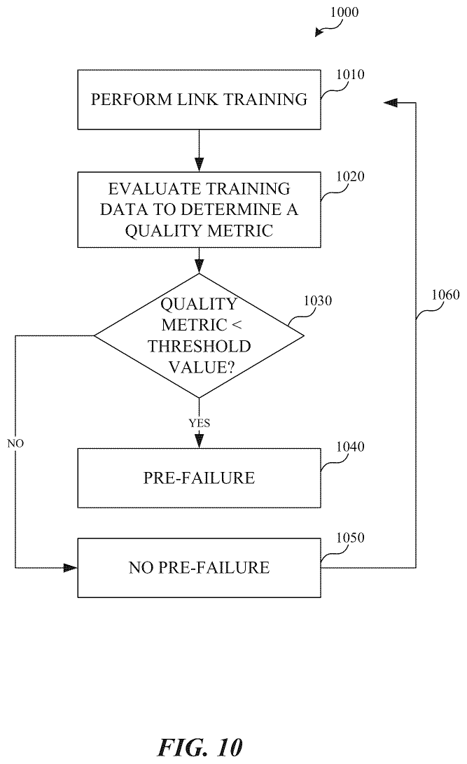

FIG. 10 illustrates a method 1000 in accordance with some aspects of the disclosure.

Method 1000 starts at act 1010, when link training is performed. For example, the link training can transmit data from a transmitter to a receiver and store training data that characterizes communication over a conductive link between the transmitter and receiver.

In 1020, the training data is evaluated, and a quality metric for the conductive link is determined. For example, the quality metric can have a predetermined range (e.g., 1-100), where a given quality metric value is inversely proportional to bit error rate that was encountered during the link training.

In 1030, the method compares the quality metric to a pre-failure threshold value. For example, the pre-failure threshold value can be a predetermined value below which communication becomes hampered. The pre-failure threshold value can be above a failure threshold value at which communication fails.

If the quality metric is less than to the pre-failure threshold value (YES from 1030), then the pre-failure condition is flagged at 1040. For example, if the pre-failure threshold value is 50, a failure threshold value is 10, and the quality metric determined during 1020 is 42, then the pre-failure condition is flagged. At this point, the method can provide a warning signal to enable the user to correct the pre-failure condition. In some cases, the warning signal may further indicate how long is expected until the quality metric drops below the failure threshold value, thereby allowing the user to make an objective decision about when replacement is optimal.

On the other hand, if the quality metric is greater than or equal to the threshold value (NO from 1030) (e.g., equivalently meaning the quality metric is greater than or equal to the threshold value), then the method proceeds to 1050 and no pre-failure condition is present. Thus, for example, if the pre-failure threshold value is 50, a failure threshold value is 10, and the quality metric determined during 1020 is 75, then no pre-failure condition is flagged. In this case, during 1060 the method can conduct normal data transfer over the link, and at some later time can perform additional link training to re-evaluate whether later determined quality metrics are less than the threshold value.

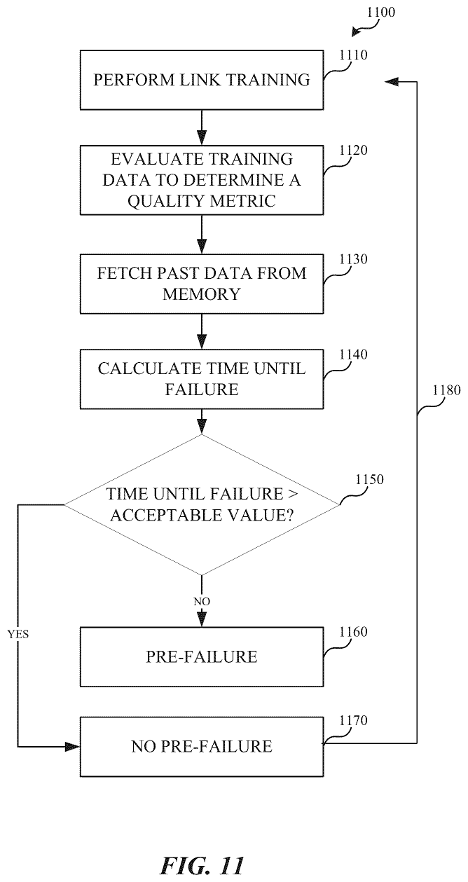

FIG. 11 illustrates another method 1100 in accordance with some aspects of the disclosure.

Method 1100 starts at act 1110, when link training is performed. For example, the link training can transmit data from a transmitter to a receiver and store training data that characterizes communication over a conductive link between the transmitter and receiver.

In 1120, the training data is evaluated, and a quality metric for the conductive link is determined.

In 1130, the method fetches past training data from memory.

In 1140, the method uses the past data and the quality metric to calculate a time until failure for the conductive link.

In 1150, the method compares the calculated time until failure to an acceptable value. For example, in some cases the acceptable value is on the order of hours, days, weeks, or months.

If the calculated time until failure is less than or equal to the acceptable value (NO from 1150), then the pre-failure condition is flagged at 1160. For example, if the acceptable value is 3 months, and the time until failure determined during 1140 is 4 days, then the pre-failure condition is flagged. At this point, during 1160 the method can provide a warning signal to enable the user to correct the pre-failure condition.

On the other hand, if the calculated time until failure is greater than the acceptable value (YES from 1150), then the method proceeds to 1170 and no pre-failure condition is present. In this case, during 1180 the method can conduct normal data transfer over the link, and at some later time can perform additional link training to re-evaluate the calculated time until failure for additional training.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

What is claimed is:

1. A device for evaluating a pre-failure condition, comprising:
a receiver configured to receive a first set of training data via a conductive link;
a comparator coupled to the receiver and configured to compare the first set of training data to a pre-determined set of training data to obtain a first set of values;
an evaluator coupled to the comparator and configured to evaluate the first set of values to obtain a first quality metric indicating a first quality of the conductive link for data transmission; and
a pre-failure detector coupled to the evaluator and configured to determine the pre-failure condition based on the first quality metric and a threshold value.

2. The device of claim 1, wherein the threshold value comprises a pre-failure threshold value, and wherein the pre-failure condition is determined in response to the first quality metric being less than the pre-failure threshold value.

3. The device of claim 1,
wherein the receiver is further configured to receive a second set of training data via the conductive link before the first set of training data;
wherein the comparator is further configured to compare the second set of training data to the pre-determined set of training data to obtain a second set of values;
wherein the evaluator is further configured to evaluate the second set of values to obtain a second quality metric indicating a second quality of the conductive link; and
wherein the pre-failure detector is further configured to determine the pre-failure condition based on the second quality metric.

4. The device of claim 3,
wherein the pre-failure detector is further configured to:
determine a quality rate of change based on the first and second quality metrics and a time interval between receiving the first and second sets of training data;
wherein the threshold value comprises a rate of change threshold value; and
wherein the pre-failure condition is determined in response to the quality rate of change being greater than the rate of change threshold value.

5. The device of claim 4, wherein the first quality metric is predicted to reach a failure threshold value based on the rate of change threshold value within a pre-failure time period.

6. The device of claim 1, wherein the first set of training data comprises a set of peripheral component interconnect express (PCIe) training data, wherein the first set of values comprises a first set of error counts, and wherein the value of the first quality metric is inversely proportional to an average value of the first set of error counts.

7. The device of claim 6, wherein the first set of values further comprises:
a first set of pre-shoot (PS) values;
a first set of boost values; and
a first set of de-emphasis (DE) values;
wherein the first quality metric is further based on the PS values, boost values, and DE values.

8. The device of claim 7, wherein the first quality metric is further based on an algorithm weighting the error counts, PS values, boost values, and DE values.

9. A method for determining a pre-failure condition for a communication link, comprising:
tuning training parameters of a receiver according to a first set of values during a first timeslot of a first training session;
determining a first-timeslot-first-training-session quality metric based on a first error count in received data when the first set of values are used during the first timeslot of the first training session;
tuning the training parameters of the receiver according to a second set of values during a second timeslot of the first training session;
determining a second-timeslot-first-training-session quality metric based on a second error count in received data when the second set of values are used during the second timeslot of the first training session;
determining a first training session quality metric based on the first-timeslot-first-training-session quality metric and the second-timeslot-first-training-session quality metric; and
determining a pre-failure condition based on the first training session quality metric.

10. The method of claim 9, wherein the first training session quality metric is an average first quality metric based on the first-timeslot-first-training-session quality metric and the second-timeslot-first-training-session quality metric.

11. The method of claim 10, wherein the pre-failure condition is determined in response to the average first quality metric being less than a pre-failure threshold value.

12. The method of claim 9, wherein a first pre-shoot (PS) value, a first boost value, and a first de-emphasis (DE) value are obtained when the first set of values are used during the first timeslot of the first training session, and wherein the determination of the first-timeslot-first-training-session quality metric is further based on an algorithm weighting the first error count, the first PS value, the first boost value, and the first DE value.

13. The method of claim 12, further comprising:
performing one or more training sessions before the first training session;
wherein the weighting of the algorithm is based on the one or more training sessions.

14. The method of claim 9, further comprising:
tuning the training parameters of the receiver according to the first set of values during a first timeslot of a second training session;
determining a first-timeslot-second-training-session quality metric based on a third error count in received data when the first set of values are used during the first timeslot of the second training session;
tuning the training parameters of the receiver according to the second set of values during a second timeslot of the second training session;
determining a second-timeslot-second-training-session quality metric based on a fourth error count in received data when the second set of values are used during the second timeslot of the second training session;
determining a second training session quality metric based on the first-timeslot-second-training-session quality metric and the second-timeslot-second-training-session quality metric; and
determining the pre-failure condition based on a difference between the first training session quality metric and the second training session quality metric.

15. The method of claim 14, wherein the second training session quality metric is a second average quality metric based on the first-timeslot-second-training-session quality metric and the second-timeslot-second-training-session quality metric.

16. A method for determining a pre-failure condition for a communication link, comprising:
tuning training parameters of a receiver according to a first set of values during a first training session;
determining a first quality metric based on a first error count in received data when the first set of values are used during the first training session;
tuning the training parameters of the receiver according to the first set of values during a second training session;
determining a second quality metric based on a second error count in received data when the first set of values are used during the second training session; and
determining a pre-failure condition based on the first quality metric and the second quality metric.

17. The method of claim 16, wherein the first training session is performed upon a first system startup, and wherein the second training session is performed upon a second system startup after the first system startup.

18. The method of claim 16, further comprising:
determining a quality function based on the first and second quality metrics and a time interval between the first and second training sessions; and
calculating a predicted time until failure based on the quality function and a time of the second training session;
wherein the pre-failure condition is determined in response to the predicted time until failure being less than an acceptable time until failure.

19. The method of claim 18, wherein the quality function is further based on a plurality of quality metrics obtained before the first quality metric.

20. The method of claim 16, further comprising storing the first and second quality metrics in a memory.
